(19) United States
(12) Patent Application Publication
(10) Pub. No.: US 2008/0286514 A1
(43) Pub. Date: Nov. 20, 2008

(54) Bondably Coated Metallic Member

(75) Inventors: Catherine Lam, Thornhill (CA); David K. Potter, Guelph (CA); Robert E. Steele, Richmond Hill (CA)

Correspondence Address: LAW OFFICE OF DELIO & PETERSON, LLC., 121 WHITNEY AVENUE, 3RD FLLOR, NEW HAVEN, CT, 06510, US

(73) Assignee: SHAWCOR LTD., Toronto (CA)

(21) Appl. No.: 11/911,974

(22) PCT Filed: Apr. 20, 2006
(86) PCT No.: PCT/CA2006/000638

§ 371 Date: May 20, 2008

(30) Foreign Application Priority Data
Apr. 21, 2005 (CA) 2,504,791

(51) Int. Cl. B32B 1/08; B05D 5/00; B05D 3/04; B05D 3/06; B05D 3/08; B05D 3/10; B05D 3/12

(52) U.S. Cl. 428/36.6; 428/36.9; 427/265; 427/535; 427/553; 427/532; 427/275; 427/273

(57) ABSTRACT

The present provides a bondably coated metallic member comprising a metallic member having a low surface energy polymeric coating, said low surface energy polymeric coating having been surface activated on at least a portion thereof, and having on said surface-activated portion a bondable high surface energy polymeric coating. The present invention also provides a bondably-coated metallic pipe comprising metallic pipe having a low surface energy mainline polymeric coating thereon extending over the pipe except at a bare zone adjacent each end of the pipe that is free from said main-line coating; a portion of said mainline coating adjacent each bare zone having been surface activated and having on said surface activated portion a bondable high surface energy polymeric coating.

### FIELD OF INVENTION

The present invention relates to the preparation of polymeric coated metallic substrates, and in particular polymeric coated metallic substrates having high energy surfaces.

### BACKGROUND

Layers of low surface energy polymers are often used as protective coatings on metal members against corrosion and against ingress of moisture. For example, polyethylene and polypropylene are commonly included in steel pipe coatings.

However, the difficulty in forming a bond to such low surface energy coatings may give rise to problems in use. For example, when pipes intended to be welded together to form pipeline are coated, a short section at either end of the pipe must be left bare (the so-called “cut-back”) so that the pipes can be welded together in the field to form a pipeline. After welding, the bare sections and the weld joint must be coated with a suitable anti-corrosion coating (field joint coating) whose performance is expected to equal or exceed that of the coating on the body of the pipe (“mainline coating”). The field joint coating commonly comprises a liquid curable coating, for example an epoxy material. Unfortunately, such materials will not typically form a strong, long-lasting bond to the polyolefin mainline coating because polyolefins, such as polyethylene or polypropylene, have no functional chemical groups to which the liquid coating can attach.

To overcome this, it is known to surface activate low surface energy polymers by subjecting them to a wide variety of conventional surface activation methods, such as for example corona discharge, plasma treatment or flame treatment. Such surface activation creates reactive or polar chemical groups with which a high surface energy coating, such as an epoxy, can react or interact, thereby allowing strong bonding of coatings, inks and adhesives to the polymer. However, known surface activation methods are not a viable approach in the case of coated pipe, since the activated surface is only a few molecules thick, generally short-lived, and does not withstand the procedures necessary in the field to clean and decontaminate the surfaces before application of the field joint coating, which may include cleaning with a strong organic solvent and/or physical abrasion, such as by grit blasting.

### SUMMARY OF INVENTION

In a first aspect, the invention provides a bondably-coated metallic member, comprising a metallic member having a low surface energy polymeric coating, said polymeric coating having been surface activated on at least a portion thereof, and having on said surface-activated portion a bondable high surface energy polymeric coating.

In a second aspect, the invention provides a bondably-coated metallic pipe comprising metallic pipe having a low surface energy mainline polymeric coating thereon extending over the pipe except at a bare zone adjacent each end of the pipe that is free from said mainline polymeric coating; a portion of said mainline polymeric coating adjacent each bare zone having been surface activated and having on said surface activated portion a bondable high surface energy polymeric coating.

In a third aspect, the invention provides a method of preparing a bondably coated metallic member comprising the steps of: (a) providing a metallic member; (b) applying a low surface energy polymeric coating to the metallic member; (c) activating at least one portion of the surface of the polymeric coating; (d) applying to the surface-activated portion of the polymeric coating a liquid bondable high surface energy polymeric coating; and (e) solidifying the liquid bondable high surface energy polymeric coating.

In a fourth aspect, the invention provides a method of preparing a bondably coated metallic pipe comprising the steps of: (a) providing a metallic pipe; (b) applying a low surface energy mainline polymeric coating to the pipe, said mainline polymeric coating extending over the pipe except at a bare zone adjacent each end of the pipe; (c) activating at a least a portion of the mainline polymeric coating, said portion of the mainline polymeric coating being adjacent to a bare zone; (d) applying to each of the surface-activated portions of the mainline polymeric coating a liquid bondable high surface energy polymeric coating; and (e) solidifying the liquid bondable high surface energy polymeric coating.

In a fifth aspect, the invention provides a method of preparing a pipeline comprising the steps of: (a) providing a first and second bondably-coated metallic pipe comprising metallic pipe having a low surface energy mainline polymeric coating thereon extending over the pipe except at a bare zone adjacent each end of the pipe that is free from said mainline polymeric coating; a portion of said mainline polymeric coating adjacent each bare zone having been surface activated and having on said surface activated portion, a bondable coating comprising a high surface energy polymeric coating that will react with and bond to the mainline coating; (b) mating one bare end of the first bondably-coated metallic pipe with one bare end of the second bondably-coated metallic pipe; (c) welding the end of the first bondably-coated metallic pipe to the end of the second bondably-coated metallic pipe to provide a welded joint; (d) treating at least a portion of the surface of the bondable coating to expose a region having enhanced capability for reacting with bonding to a field joint coating; and (e) applying said field joint coating to the welded joint and over said exposed region of bondable coating.

### BRIEF DESCRIPTION OF THE FIGURES

FIG. 1 a schematic illustration of a typical 3-layer polyolefin coating.

FIG. 2 is a schematic illustration of plasma surface treatment of a coating at an end of a pipe.

FIG. 3 is a schematic illustration of an application of a permanent bondable coating to an end of pipe which has been surface-activated.

FIG. 4 is a schematic illustration of the steps in the application of polyolefin coating and a bondable coating to a steel pipe.

FIG. 5 is a schematic illustration of the steps in the application of a field joint coating to a steel pipe having a bondable coating.

FIG. 6 is a schematic illustration of a liquid coating bondable interface system for a 3-layer polyolefin coating.

FIG. 7 is a line graph comparing the percentage adhesive failure of primer coating at the bondable layer/PE interface versus the number of days after flame treatment.

FIG. 8 comprises photographs (a) to (d). Photo (a) illustrates failure at the epoxy bondable layer (EBL)/polyethylene interface, polyethylene cohesive failure and cohesive failure of the epoxy joint coating. Photo (b) illustrates failure at the interface between polyethylene and a UV curable bondable layer (UVBL). Photo (c) illustrates failure at the fusion bonded epoxy-polyethylene interface, failure at the UVBL/PE interface and cohesive failure in the epoxy joint coating. Photo (d) illustrates various failure modes on UV bondable layer test dollies.

### DETAILED DESCRIPTION

To overcome the difficulty of bonding polar materials to non-polar ones, it is known to modify the surface of the polyolefin in order to promote adhesion to higher surface energy adhesives. This is referred to as “activating” the surface, and consists of attaching functional or polar chemical groups to the surface.

Oxidation of the surface is an effective and well-known method. One common method of accomplishing this is to expose the polyolefin surface to an oxygen-rich flame. Another way is to expose the surface to a corona discharge, which contains oxygen radicals capable of creating oxygenated species, such as hydroxyl, carbonyl, and carboxylic acid groups on the surface. Another well-known method of activating the surface of a low surface energy polymer is reacting it with a strong oxidizing agent, such as chromic acid, a peroxide, or halogen gas, such as fluorine or chlorine.

It is also well known to activate a low energy surface by exposing it to high-energy gas plasma, which creates highly reactive species from the ionized gas. The chemical nature of the active species depends upon, and can be controlled in part by, the composition of the gas that makes up the plasma. Thus, active groups other than those based on oxygen can be created on the surface of the low surface energy polymer.

Yet another known method of altering the surface energy and reactivity of a low energy surface is to graft it with a polar or functional polymer, such as an acrylic acid or ester, including esters capable of reaction with epoxy groups, such as glycidal acrylate or glycidal methacrylate. In such cases it is possible to create films of greater thickness than by the previously described processes, but such films are in practice typically still only a few microns thick.

Such processes can provide a high-energy surface capable of bonding to polar adhesives, but it is well known that the surface energy of such treated surfaces can decrease with time. It is also well known that such surfaces are very fragile. In the case of coated pipe, such treatments do not represent a viable approach because it is very common for the pipe to be stored for periods much in excess of the normal life expectancy of the surface treatment. Furthermore, such surfaces are only a few molecules thick, and could not withstand the procedures necessary in the field to clean and decontaminate the surface, such procedures often including cleaning with a strong organic solvent and/or physical abrasion, such as by grit blasting.

Apart from coated pipe, there are numerous other low surface energy polymer-coated rigid structural metal products that are subjected to conditions that are detrimental to surface activation at the time of end use of the product, and that would benefit from provision of a reliably long-lived bondable coating. Such products include, for example, polymer-coated aircraft parts and automotive body parts, such as car bumpers that are intended to be painted or further coated before use.

A further problem with the surface treatment methods described above is that the polar groups formed may not be capable of chemically reacting with the chemical groups in the high surface energy coating. This may lead to a bond that is initially strong, but which is easily dislodged through exposure to the elements, or which simply decreases with time. Such circumstance would limit the formulation choices available for the high surface energy coating.

The present invention provides a method of treating the surface of a low-surface energy polymer in such a way that the ability to bond a high surface energy coating to same is retained for a much longer period of time. The invention provides improved compatibility with the high surface energy coating by providing greater leeway to incorporate chemical groups capable of reacting with the chemical groups in said high surface energy coating. The invention provides treated surfaces which are sufficiently robust to be able to withstand processes in the field for cleaning or decontaminating said treated surface.

In a first aspect, the invention provides a bondably-coated metallic member, comprising a metallic member having a low surface energy polymeric coating, said polymeric coating having been surface activated on at least a portion thereof, and having on said surface-activated portion a bondable high surface energy polymeric coating. Surprisingly, it has been found that with such bondable coatings, bonds of such excellent strength can be achieved that, when multiple layer coatings are subjected to tensile bond strength testing, failure tends to occur predominantly cohesively within one of the layers, and not at the interface between the surface-activated polymer and the bondable coating.

In the most useful applications of the present invention, the metallic member comprises a rigid, self-supporting member, for which it is an important characteristic that coatings applied thereto exhibit strong adhesion to the substrate or to the intermediate coatings on which they are intended to bond. Examples of metallic members in preferred embodiments of the invention include aluminium, aluminium alloy and steel architectural structural and cladding panels, aluminium, copper and zinc roofing members and aircraft and automotive body parts, usually of aluminium, aluminium alloy or steel. In a particularly preferred embodiment, the metallic member comprises pipe, usually steel pipe, and more preferably, steel pipe intended to be employed in pipeline.

In a second aspect, the invention provides a method of preparing a bondably-coated metallic member comprising the steps of: (a) providing a metallic member; (b) applying a low surface energy polymeric coating to the metallic member; (c) activating at least one portion of the surface of the polymeric coating; (d) applying a liquid bondable high surface energy polymeric coating to the surface-activated portion of the low surface energy polymeric coating; and (e) solidifying the liquid bondable high surface energy polymeric coating.

By the term “polymer”, as used herein, we mean homo-polymers, co-polymers and/or their blends and alloys with other polymers and/or natural and synthetic rubbers, and polymer matrix composites, on their own, or alternatively as an integral and uppermost part of a multi-layer laminated sandwich comprising any materials e.g. polymers, metals or ceramics, or an organic coating on any type of substrate material.

The low surface energy polymeric materials which may be used to prepare the bondably-coated metallic members according to the invention include, but are not limited to: polyolefin homopolymers or copolymers, particularly polyethylene (PE), polypropylene (PP), ultra high molecular weight polyethylene (UHMWPE), blends of polyolefins with other polymers or rubbers; polyvinylidenefluoride (PVDF), polytetra-fluoroethylene (PTFE), fluorinated ethylene-propylene copolymer (FEP) and ethylene propylene diene mixture (EPDM).

In a preferred embodiment of the invention, the low surface energy polymeric coating is a multi-layered polymeric coating having an outer layer comprised of a polyolefin polymer. The most common examples of such are: 2-layer polyolefin coatings, having a layer of polyolefin bonded to the metal surface with an adhesive or sealant, three-layer polyolefin coatings, comprising: (1) a cured primer layer, (2) an adhesive, and (3) a polyolefin top layer, and composite coatings, comprising a gradient composition of fusion-bonded epoxy coating at the surface of the pipe to pure polyolefin at the exterior of the coating. Such polyolefin coatings are well known in the art.

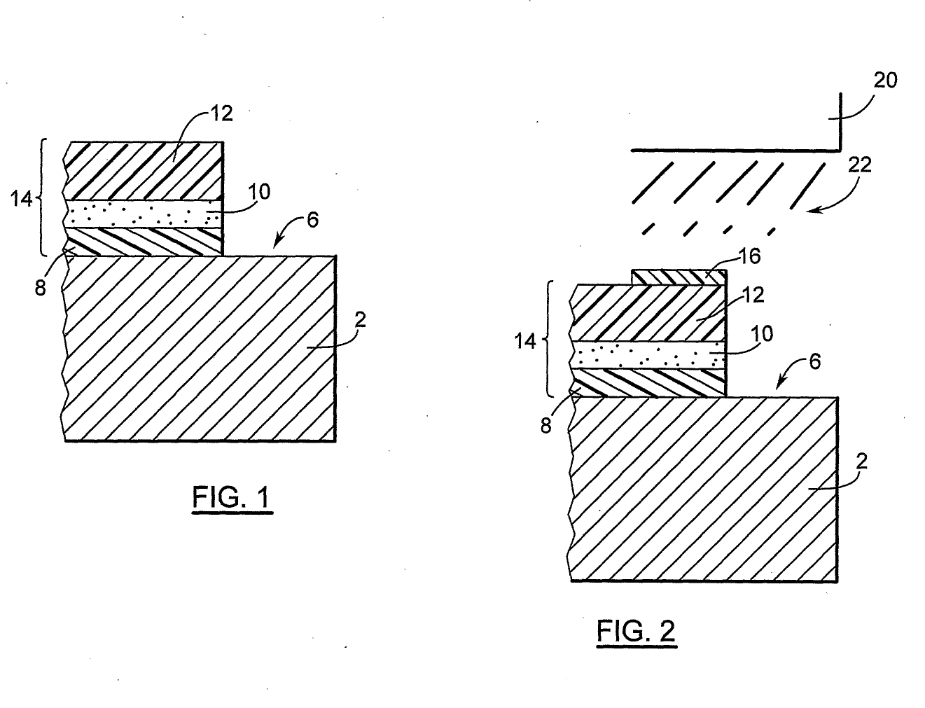

FIG. 1 shows a portion of a wall 2 of a coated pipe having a typical three-layer polyolefin mainline coating 14 and a bare cut-back portion 6. As shown in FIG. 1, the curable primer layer 8 is most commonly fusion-bonded epoxy powder (FBE) coating. The adhesive layer 10 typically comprises one or more polyolefin copolymers containing polar groups capable of interacting with the curable coating, while retaining the ability to bond well to the polyolefin coating. Such adhesives are typically graft copolymers of ethylene or propylene with very small amounts of maleic anhydride, which forms a covalent bond with the FBE. The top polyolefin layer 12 is typically comprised of polypropylene or polyethylene.

The polymeric coating can be applied to the metallic member using any suitable method known in the art. Generally, the surface of the metallic member to be coated is cleaned prior to the application of the polymeric coating. The surface of the metallic member can be cleaned by chemical means such as the use of a detergent or organic solvent and/or by physical means such as shot blasting or grit blasting. To promote adhesion of the polymeric coating to the surface of metallic member, an acid wash can be also employed to improve surface roughness and to remove soluble salts.

Where the polymeric coating is a three-layer polyolefin coating, the components comprising the polymeric coating can be applied in powder form using electrostatic powder application techniques known in the art. Generally, the metallic member is pre-heated to a suitable powder application temperature of about 240° C. The metallic member can then be dipped into a fluidized bed of FBE and then sprayed with a suitable polyolefin adhesive. The polyolefin polymer can then applied to the metallic member and the excess polymer powder removed. The metallic member is then briefly heated at 240° C. to liquefying the polymer powder. The resulting polymeric coating can then be solidified by quenching in cool water bath.

Following the application of the low surface energy polymeric coating, the next step in the preparation of the bondably-coated metallic member of the invention is the activation of at least a portion of the surface of the low surface energy polymeric coating. As discussed above, numerous surface activation techniques are known in the art and any suitable method may be used to activate the surface of the low surface energy polymeric coating.

The surface of the low surface energy polymeric coating may be activated by physical or chemical oxidation techniques. Examples of physical oxidizing methods include but are not limited to: corona discharge, flame treatment, plasma treatment or UV irradiation. Chemical oxidizing agents which may be employed include, but are not limited to: chromic acid, peroxides, and halogen gases such as fluorine and chlorine. Where the polymeric coating comprises a polyolefin, the preferred method of surface activation is plasma treatment. More preferably, the activation method is atmospheric plasma treatment wherein a plasma is generated at ambient pressure using a PlasmaTreat® plasma generator or a similar device. The length of exposure to the plasma will depend on the type of polyolefin employed.

In a preferred form, the plasma is generated by forcing a stream of gas between electrodes. The plasma is composed of ions, radicals, neutral species, and highly energetic electrons. The active species react with the polymeric coating to create polar functional groups on its surface. The types of polar functional groups formed on the substrate surface are dependent on the ionizable gas selected. For example, if an oxygen-containing gas is used, oxygen-containing functional groups, such as hydroxyl and carbonyl groups will be formed, whereas if a nitrogen-containing gas is used, nitrogen-containing functional groups, such as amine groups, will be formed. Suitable gases include but are not limited to: oxygen-containing gases and/or aerosols, such as oxygen (O₂), carbon dioxide (CO₂), carbon monoxide (CO), ozone (O₃), hydrogen peroxide gas (H₂O₂), water vapour (H₂O) or vaporised methanol (CH₃OH), nitrogen-containing gases and/or aerosols, such as nitrous gases (NOₓ), dinitrogen oxide (N₂O), nitrogen (N₂), ammonia (NH₃) or hydrazine (H₂N₄).

In another embodiment of the invention, the preferred method of surface activation is grafting of a polar or functional polymer to the surface of the low surface energy polymeric coating. Surface grafting is particularly useful because it allows improved control over the chemical nature of the surface modified surface. If, for example, maleic anhydride is grafted onto the surface, it will be known that there can be a chemical reaction with, for example, the primary amine-containing component of a two-component liquid epoxy. If, on the other hand, the graft contains primary amine groups, it will be known that it can react with the isocyanate component of a two-component polyurethane coating, or with the epoxy groups of a two-component epoxy coating. Where it is desired to use an epoxy as the bondable coating, it is particularly advantageous to graft an epoxide-bearing molecule, such as glycidyl methacrylate or glycidyl acrylate.

Following surface activation of at a least a portion of the low surface energy polymeric coating, the surface activated portion is coated with a bondable high surface energy polymeric coating. In a preferred embodiment, the bondable high surface energy polymeric coating is applied immediately following surface activation of the low surface energy polymeric coating. Preferably the bondable high surface energy polymeric coating is applied within at least 10 days of surface activation of the low surface energy polymeric coating and more preferably within at least 5 days of surface activation of the low surface energy polymeric coating.

The bondable high surface energy polymeric coating is comprised of a material capable of forming a strong bond with both the activated surface of the low surface energy polymeric coating and the coating which will be applied in the field. Where the metallic member is a pipe intended for field use, the bondable high surface energy polymeric coating is comprised of a material which is also capable of forming a strong bond with field joint coatings such as anti-corrosion coatings. The bond between the bondable coating and the polymeric coating and the field joint coating may be due to Van der Waal or ionic interactions. Preferably, the bondable high surface energy polymeric coating is comprised of a material capable of reacting with reactive groups on the activated low surface energy polymeric coating or the field coating to form covalent bonds.

In an embodiment of the invention, the bondable high surface energy polymeric coating is comprised of a thermoplastic having reactive surface groups. Examples of such thermoplastics include but are not limited to: polyurethane; polyamides, such as poly(hexamethylene adipamide) (Nylon-6,6); polystyrene; polyesters such as polyethylene terephthalate (PET).

In a preferred embodiment of the invention, the bondable high surface energy polymeric coating comprises a solid residue of a curable liquid resin. While the present invention is not limited to any particular theory, it is believed that curable liquid resins provide superior adhesion to the activated low surface energy polymeric coatings. The superior adhesion properties of cured liquid resins are believed to arise as a result of the degree of interaction achievable between functional groups on the activated polymeric surface and the molecules that make up the curable liquid resin, as a result of the mobility of molecules in the liquid state.

Examples of curable liquid resins suitable for practicing the invention include those that cure to relatively hard coatings based on the reaction of a curable liquid resin with a curing agent. Examples comprise coating systems based on the reaction of polyepoxy resins with polyamine curing agents. The two parts are mixed together before application to the activated substrate. Commercial examples of two part epoxy compositions include but are not limited to: E-Primer™ (Canusa-CPS, division of ShawCor Ltd. Toronto, Canada); AMERCOAT CC0022A (Ameron International Performance Coatings and Finishes Group, Alpharetta, Ga., USA); Prime Shield (Sherwin Williams, Cleveland, Ohio, USA); SigmaCover CM (Sigma Coatings, Amsterdam, Netherlands); Sigma Novaguard (Sigma Coating); Sigmarite EPH (Sigma Coating).

Another example of a suitable bondable coating includes curable liquid resins employing the reaction of a polyisocyanate with a polyol (polyurethane resins). Commercial examples of suitable 2 component urethane coatings include but are not limited to: Polane Primer-Sealer (Sherwin Williams, Cleveland, Ohio, USA); 178 HS Primer Surfacer (Ameron International Performance Coatings and Finishes Group, Alpharetta, Ga., USA); and SigmaDur (Sigma Coatings, Amsterdam, Netherlands).

A further example of a suitable bondable coating includes curable liquid resins employing the reaction of a polyisocynate with a polyamine (polyurea resins). Commercial examples of 2 component polyurea coatings include but are not limited to: Epoxy System Product #916 (Epoxy System, Orlando, Fla., USA), 930 Polyurea Joint (Epoxy System); PERMAX-700 (Resin Technology Co., Ontario, Calif., USA), PERMAX-700 HP (Resin Technology Co.); FX-640 (Fox Industries, Baltimore, Md., USA); FX-645 (Fox Industries); and FX-644CR (Fox Industries).

While the application of liquid or, more preferably, gaseous curing agents is contemplated, in the most preferred form the curable resin is a radiation curable resin and the step of hardening the layer comprises exposing the layer to cure inducing radiation. Ultraviolet light (UV) curable coatings are particularly preferred because of the rapid polymerization of the UV curable compositions. These coatings offer several advantages for the processing of bondably coated products such as pipes. It is desirable for the bondable coating to be hardened to its final state at the end of the bondable coating application process. By achieving the final hardened state by the end of the coating process, marring of the coating due to contact with machinery encountered in subsequent processing steps is avoided. This minimizes repair and rework. A highly reproducible degree of cure is achieved. Additionally, if a suitably thixotropic coating has been formulated, concerns with the timing of the cure event are eliminated since no cure will take place until irradiation with UV light has ensued. This allows the processing operation to be more flexible. Issues associated with the processing of two component coatings, such as the mixing of off-ratio blends, are also eliminated. The excessive heating of the mill coat that can occur with heat activated coating systems is also avoided. These advantages result in a higher quality application of the bondable layer. Furthermore, ultraviolet irradiators are cost effective and easy to use.

Other examples of suitable curable liquid resins include coatings based on free radical polymerization such as acrylic resins and vinyl ether resins. The inventors have formulated a novel acrylate based coating which is particularly suitable for practicing the invention. In an embodiment of the invention, the bondable coating is an acrylated based coating comprising: approximately 43.8 parts tri-functional urethane acrylate (CN929, Sartomer, Exton, Pa., USA); approximately 43.8 parts ethoxylated trimethylopropane triacrylate (SR454, Sartomer); approximately 9.2 parts trifunctional acid ester (CD9052, Sartomer); approximately 2.9 parts 1-hydroxy-cyclohexyl-phenyl-ketone (Igracure 184, CIBA Specialty Chemicals, Tarrytown, N.Y., USA); and approximately 0.3 parts blue colourant in unsaturated ether (PE 33, CPS Colour, Charlotte, N.C., USA). The novel acrylate coating is UV curable and is particularly useful in the preparation of coated pipes. The addition of a colourant, or other means that impart a visually distinguishable appearance to the bondable coating as compared to the mainline coating, allows for the preparation of coated pipes which are easily distinguishable as pipes having a bondable coating by simple visual inspection.

The choice of the curable liquid resin will depend on the low surface energy polymeric coating employed and the surface chemistry of the activated portions of the low surface energy polymeric coating. Where the surface chemistry of the activated coating includes hydroxyl groups, it is preferable to use a polyurethane resin as the bondable coating, since the isocyanate component of the polyurethane resin readily reacts with hydroxyl groups. Where the surface chemistry of the coating includes amine or epoxide groups, it is preferable to use an epoxy resin.

Where the metallic member is a pipe, the choice of the curable liquid resin will also depend on the surface chemistry of the field joint coating. Field joint coatings may include liquid coatings, thermoset powder coatings, and polar thermoplastic coatings. Liquid coatings include, but are not limited to, epoxies, polyurethanes, polyureas, and acrylics. Powder coatings include, but are not limited to, epoxy, and phenolics. Thermoplastic coatings include, but are not limited to, polyamides, thermoplastic urethanes, polyolefins grafted with polar functional groups, and hot melt adhesives based on copolymers of ethylene or propylene. The preferred field joint coating is typically a two-component liquid epoxy. In these cases, it is preferable to use either a polyurethane resin or an epoxy resin as the bondable coating.

The bondable high surface energy polymeric coating may be applied by any method suitable for the consistency and hardening characteristics of the particular coating. If the coating is applied as a liquid, examples of such methods are brushing, spraying, rolling, and reverse roll transfer coating. Where the bondable coating is a thermoplastic material, it may be applied by extrusion flame spray, solution coating, or injection moulding. Application of molten high surface energy polymers to the activated surface is best carried out at temperatures below the melting point or the upper operating temperature of the low surface energy polymeric coating to ensure good bonding.

The coatings of the bondably-coated metallic member of the invention exhibit strong adhesion properties and are reliably long-lived. To ensure these characteristics, the applied bondable high surface energy polymeric coating is preferably, relatively thick. The use of a robust bondable coating assists in maintaining the functionality of the coating subsequent to its application. This is particularly advantageous wherein the bondably-coated metallic member is a pipe. In the case of pipes used in the field, it is necessary that the bondable coating be still functional by the time the pipe has been transported to the field, welded up, and is ready for the field joint coating to be applied. In the past, this usually involved the application of some form of interim protection capable of withstanding the handling, storage, transportation, stringing and welding of the pipe. For example, the coating could be protected with plastic tape, an uncoated polyethylene shrink sleeve, a plastic cap, or a peel-away coating.

The present invention provides coatings which will stay intact throughout the processes discussed above, and which are capable of being conveniently and reliably cleaned of any contamination in the field. In the case of pipes, because the weld joint is typically cleaned by blasting it with sand or grit prior to applying the field joint coating, it is particularly useful if the bondable coating is capable of being cleaned in the same way. It is common practice, for example, to lightly blast fusion bonded epoxy mainline coating prior to the application of epoxy field joint coating. Such blast cleaning not only removes contamination, but also exposes a fresh, chemically active surface that is beneficially rough to enhance adhesion. Thus, in a preferred embodiment, the bondable coating is robust enough to be able to withstand brief exposure to the same blasting process as is used to clean the metal, and that it be of a nature that it will not catch and retain the blast medium. In order to withstand blast cleaning, the bondable coating can be formed to be of a substantial thickness, and preferably hard enough that the blast medium will not penetrate into and be captured by the coating. Where a robust bondable coating is desired, it is preferable that metallic member be applied with a bondable coating which is between 1 μm and 5000 μm thick and more preferably between 100 μm and 1000 μm.

Following application of the bondable high surface energy polymeric coating in liquid form to the surface-activated portions of the low surface energy polymeric coating, the liquid bondable coating is solidified by cooling, curing, or drying. In cases where the bondable high surface energy polymeric coating comprises a resin, the bondable coating is solidified by curing methods such as exposure to UV radiation, infrared radiation or heat. In a preferred embodiment of the invention, the bondable high surface energy polymeric coating comprises a curable liquid resin which is curable at temperatures below the upper service temperature of the low surface energy polymeric coating. The inventors have determined that the use of liquid resins which are curable at temperatures below the upper service temperature of the activated substrate provide superior bonding qualities as compared to the bondable coatings comprised of solid or molten resins.

In a further aspect, the invention provides a bondably-coated metallic pipe comprising metallic pipe having a low surface energy mainline polymeric coating thereon extending over the pipe except at a bare zone adjacent each end of the pipe that is free from said mainline coating; a portion of said mainline coating adjacent each bare zone having been surface activated and having on said surface activated portion a bondable high surface energy polymeric coating. As used herein in the context of coated pipes, the term “mainline coating” refers to a coating which is applied to the body of the pipe excluding the cut-back portions at each of the ends of the pipe.

In an embodiment of the invention, the bondable high surface energy polymeric coating is treatable such that treatment of the bondable high surface energy polymeric coating exposes the reactive surface groups on the surface activated portion of the mainline polymeric coating, which are capable of reacting with chemical groups in a liquid resin such as a field coating. The bondable high surface energy polymeric coating may be treatable with an abrasive agent such as shot, grit, or sand. The bondable high surface energy polymeric coating may also be treatable with a chemical agent such as a detergent or a suitable organic solvent which does not negatively affect the ability of the underlying activated portions of the mainline polymeric coating to bond to a liquid resin.

The invention further provides a method of preparing a bondably-coated metallic pipe comprising the steps of: (a) providing a metallic pipe; (b) applying a mainline polymeric coating to the pipe, said mainline polymeric coating extending over the pipe except at a bare zone adjacent each end of the pipe; (c) activating at a least a portion of the mainline polymeric coating, said portion of the mainline polymeric coating being adjacent to a bare zone; (d) applying a liquid bondable high surface energy polymeric coating to each of the surface-activated portions of the mainline polymeric coating; and (e) solidifying the liquid bondable high surface energy polymeric coating.

Any of the polymeric and bondable coatings previously discussed above can be used to prepare the bondably-coated metallic pipe.

In the preparation of a bondably-coated pipe, typically only a portion of the low surface energy polymeric coating will be surface activated. FIG. 2 illustrates the use of a plasma generator 20 to generate plasma 22 to treat a portion of the polymeric coating 14 to yield an activated surface 16. As shown in FIG. 2, generally only a portion of the polymeric coating 14 adjacent to the cut-back portion 6 of the pipe 2 is surface activated. The cut back portion of the pipe is a bare zone on the pipe which is not coated. Surface activation of the polymeric coating can be achieved by any of the activation methods discussed above including but not limited to the use of physical oxidizing agents (i.e. flame treatment, plasma treatment, corona discharge, UV irradiation), chemical oxidizing agents (i.e. chromic acid, peroxides, halogen gases), and by surface grafting with a functional or polar polymer. Preferably, the polymeric coating is surface activated by atmospheric plasma treatment using a low temperature plasma.

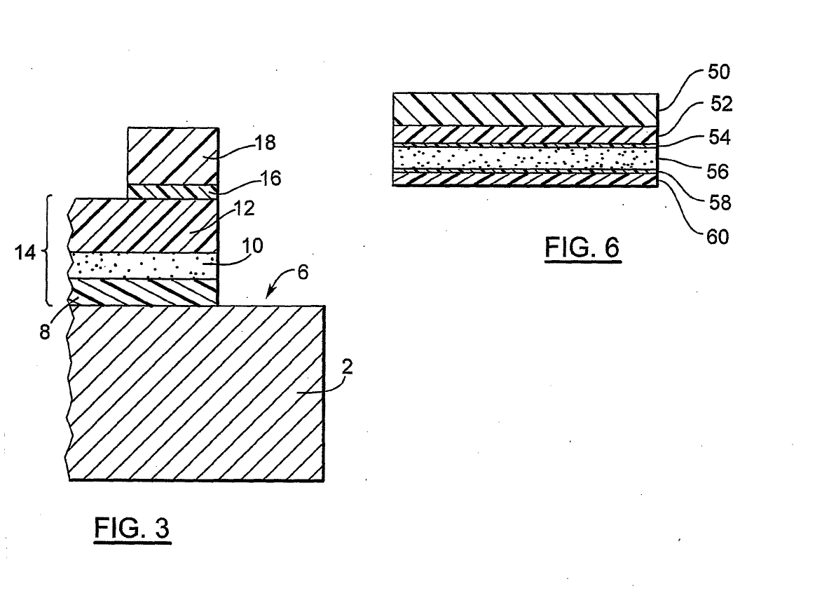

As seen in FIG. 3, where the metallic member is a pipe, the bondable high surface energy polymeric coating 18 is applied to the activated portion 16 of the low surface energy polymeric coating 14 adjacent to the cut back portion 6 of the coated pipe 2.

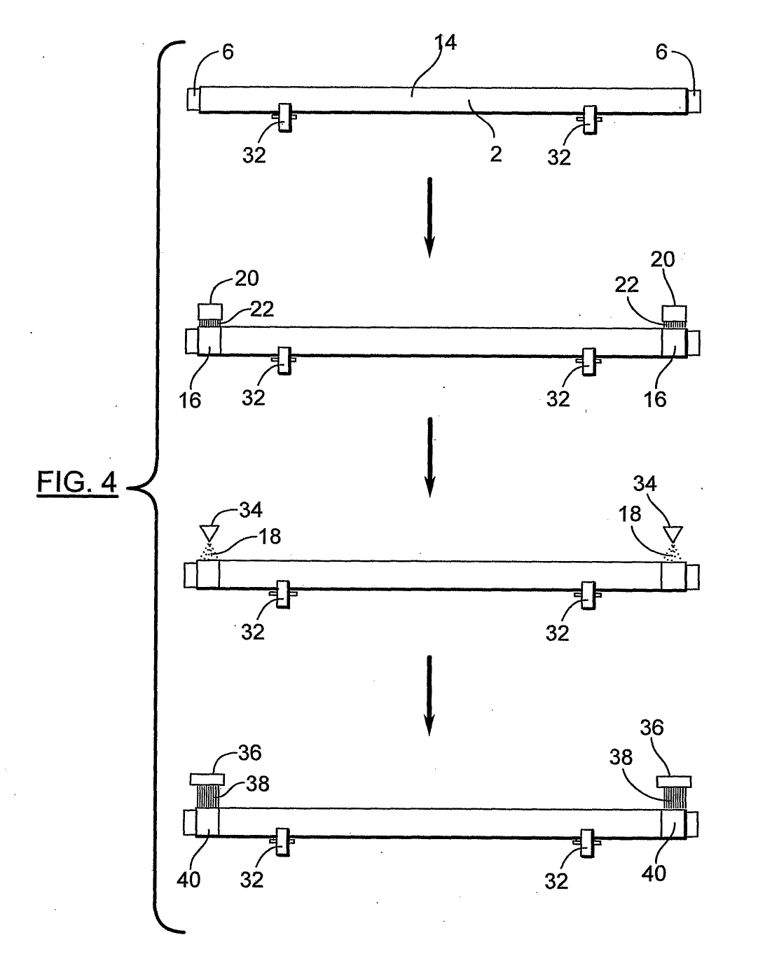

The bondable high surface energy polymeric coating may be any of the liquid coatings discussed above. The selection of the bondable high surface energy polymeric coating will depend on the surface chemistry of both the activated low surface energy polymeric coating and the surface chemistry of the field joint coating. The bondable high surface energy polymeric coating can be applied to the surface-activated portion of the low surface energy polymeric coating using any suitable method known in the art including brushing, spraying, rolling, reverse roll transfer or extrusion. The method of solidifying the coating will depend on the type of coating selected but generally includes exposure to heat, ultraviolet radiation, infrared radiation, drying, or simple cooling in the case of coatings applied in the molten state. FIG. 4 illustrates the preparation of a bondably-coated pipe 2 for use in the field. In an embodiment of the invention, a pipe which has been freshly coated with the low surface energy polymeric coating 14 is placed on a rotator 32. The coated pipe 2 is then rotated while the ends of the coated pipe are exposed to plasma 22 produced using a suitable plasma generator 20. The bondable high surface energy polymeric coating 18 comprising a curable liquid resin is then applied to the activated portions 16 of the low surface energy polymeric coating using a suitable means such as a sprayer 34. The bondable high surface energy polymeric coating 18 is then cured to a solid coating 40 by exposing the bondable high surface energy polymeric coating 18, for example to UV radiation 38 from a UV source 36.

In another aspect, the invention provides a method of preparing a pipeline comprising the steps of: (a) providing a first and second bondably-coated metallic pipe comprising metallic pipe having a low surface energy mainline polymeric coating thereon extending over the pipe except at a bare zone adjacent each end of the pipe that is free from said mainline polymeric coating; a portion of said mainline polymeric coating adjacent each bare zone having been surface activated and having on said surface activated portion, a bondable coating comprising a high surface energy polymeric coating that will react with and bond to the surface activated mainline coating and will react with and bond to a field joint coating; (b) mating one bare end of the first bondably-coated metallic pipe with one bare end of the second bondably-coated metallic pipe; (c) welding the end of the first bondably-coated metallic pipe to the end of the second bondably-coated metallic pipe to provide a welded joint; (d) treating at least a portion of the surface of the bondable coating to expose a region having enhanced capability for reacting with bonding to said field joint coating; and (e) applying said field joint coating to the welded joint and over said exposed region of the bondable coating. In an embodiment of the invention, the surface of the bondable coating is treated using an abrasive agent such as shot, grit, or sand. In another embodiment of the invention, the surface of the bondable coating is treated using a chemical agent is detergent or an organic solvent. The type of detergent or organic solvent used will depend on the surface properties of the bondable coating and preferably does not interfere with the ability of the underlying surface activated portions of the low surface energy mainline polymeric coating to bond to a field joint coating.

Any of the polymeric and bondable coatings previously discussed above can be used to prepare the bondably-coated metallic pipe for use in the preparation of a pipeline according to the method of the invention. As previously discussed, the choice of the bondable coating will depend on the surface chemistry of both the activated low surface energy polymeric coating and the surface chemistry of the field joint coating. Preferably the low surface energy polymeric coating comprises a polyolefin such as polyethylene or polypropylene. The field joint coating is preferably a curable liquid resin such as but not limited to: a polyurethane liquid resin, an epoxy liquid resin, a polyurea liquid resin, or an acrylic liquid resin.

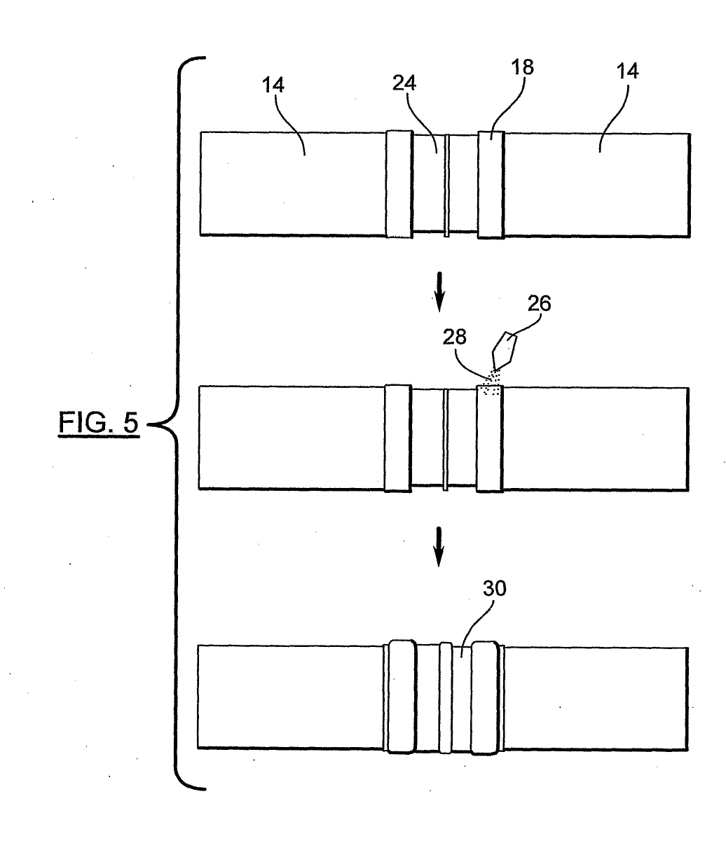

FIG. 5 illustrates the preparation of a field joint 24 using a bondably coated pipe 2 prepared in accordance with the invention. In the field, the bare cut back portions 6, as illustrated in FIG. 4, of the pipes 2 are mated and the joint 24 sealed by welding the pipes together. The welded joint is then typically cleaned by using a blasting tool 26 to spray sand or grit 28 onto the surface of the bondable high surface energy polymeric coating 18. The sand blasting also cleans the surface of the bondable high surface energy polymeric coating to reveal a fresh, chemically active surface. The joint compound 30, such as for example a liquid epoxy, is then applied to the bare steel at the joint and to the bondable high surface energy polymeric coating adjacent to the joint to seal the joint. The bondable high surface energy polymeric coating can be applied as a relatively thick layer to ensure that the bondable high surface energy polymeric coating can withstand blast cleaning. Preferably, the thickness of the bondable coating will be between 1 and 5000 μm and more preferably be between 100 and 1000 μm.

Embodiments of the invention will now be described with reference to the following Examples.

### EXAMPLE ONE

### Surface Energy Retention in Polyolefin Coatings Bonded with an Epoxy or an UV Cured Acrylic Coating

### Materials and Methods

Preparation of Steel Plates Coated with a Polyolefin Coating—Steel plates (10″×4″×¼″) were washed with dish detergent, thoroughly rinsed and dried. Then the plates were thermo-pickled in an oven overnight at 325° C. to remove organic contaminants. After the plates were cooled to room temperature, they were gritblasted to SA2.5 (white metal finish) and were immediately placed in an oven to heat at 240° C. for 3 hours. The heated plates were dipped in a fusion bonded epoxy (FBE 3M 6233) fluidized powder bath for 3 seconds, followed by a light spray of the maleic anhydride grafted polyethylene adhesive 2′; (Borealis Borcoat™ ME0433). After that, black polyethylene powder (Novapol PE from Nova Chemicals) was immediately poured over the plate and allowed to sit for 10 seconds, at which point all excess powder was shaken from the plate. The coated plates were placed in the 240° C. oven for 5 minutes. Then they were quenched in a cool water bath for approximately 5 minutes. The coated plates were allowed to dry on a shelf.

Flame Treatment—The surfaces of the coated plates were cleaned with Isopropyl alcohol before surface treatment. The cleaned coated plates (i.e., PE topcoat) were treated with a blue oxidizing flame at 10 inches/second with two passes over each area.

Bondable LayerApplication—Two bondable coatings were used in these Examples: a urethane acrylate based UV curable coating (see Table 1 for the formulation composition) and an epoxy coating used in pipeline joint finishing (E-primer Canusa-CPS, Toronto, Canada).

TABLE 1
Composition of the UV curable bondable coating.

| Raw Material | Chemical Name | Function | weight % |
|---|---|---|---|
| CN929 | tri-functional urethane acrylate | Oligomer | 43.8 |
| (Sartomer) | | | |
| SR454 | ethoxylated trimethylolpropane | Monomer | 43.8 |
| (Sartomer) | triacrylate | | |
| CD 9052 | trifunctional acid ester | Adhesion Promoter | 9.2 |
| (Sartomer) | | | |
| Irgacure 184 | 1-Hydroxy-cyclohexyl-phenyl-ketone | Photoinitiator | 2.9 |
| (CIBA | | | |
| Specialty | | | |
| Chemicals) | | | |
| PE 33 | blue colourant in unsaturated ester | Colorant | 0.3 |
| (CPS Colors) | | | |

| | |
|---|---|
| Total | 100.00 |

The UV bondable layer coating was spread across the plate with a flat-edged metal scraper on the flame treated coated polyethylene surface. The freshly coated plates were then passed through the UV coating apparatus immediately after coating. The apparatus consists of a conveyor belt and an UV light source. Coated plates were transported by the conveyor belt at a speed of 5 ft/min and passed under a Fusion F300 UV light source, located approximately 50 mm above the plate's surface (source focal point). The light bulb used in the F300 fixture was the D series bulb that emits UV light in a wavelength range of 350-400 nm. The thickness of the coating was between 3.2 mil (81.28 μm) to 7.1 mil (180.34 μm).

E-primer was mixed at the standard resin to hardener ratio of 6.06:1 by weight. Then it was applied to the flame treated polyethylene coated plates by a sponge. The coated plates were allowed to cure for 2 hours at room temperature. The thickness of the coating was between 5.1 mil (129.54 μm) to 9.5 mil (231.14 μm).

Application Sequence—UV curable coating and E-primer were each applied on ten polyethylene coated plates immediately after flame treatment. Twenty plates were left uncoated and stored on a lab shelf.

One day before adhesion testing, the UV curable coating and E-primer was each applied to one surface-treated polyethylene coated plate and cured appropriately. Then these bondable layer coated plates and one each of the previously bondable layer coated (UV and E-primer) plates (on which the bondable layer had been applied immediately after flame treatment) were gritblasted at a pressure of 35 psi.

The thickness of the plate coating, bondable layer and total coating were measured by the Thickness Gauge (DeFelsko; Model PosiTector 6000 FS2; +/−0.1 mil) and recorded.

Epoxy Coating Application—After the bondable layer was gritblasted (at 35 psi), the plate was heated in an oven at 60° C. for approximately 1 hour. A 2-part epoxy liquid coating (HBE-95, Canusa-CPS, Toronto, Canada) was mixed at a resin:hardener ratio of 4.28:1 and was applied to the heated plates with a flat-edged metal scraper. The epoxy liquid was scraped into the anchor pattern first and then a ˜30 mil thick coat was applied. The epoxy coating was allowed to dry at room temperature overnight, followed by oven curing at 60° C. for 3 hours.

FIG. 6 illustrates the whole coating system for bonding high surface energy coating (e.g. liquid epoxy coating) to polyolefin-coated (e.g. polyethylene coated) pipe. As shown in FIG. 6, the pipe is coated with three-layer polyolefin coating comprising: a layer of fusion bonded epoxy 60, a layer of maleic anhydride grafted PE adhesive 58, and a layer of polyethylene 56, the surface 54 of which has been flame treated. A bondable layer (UV or E-primer) 52 is applied to the flame treated surface 54. A layer liquid epoxy (HBE) 50 is applied to the bondable layer 52.

Pull-off Adhesion Test by Instron 4400R—Immediately after the epoxy (HBE-95) coating was coated on the heated plates, six dollies were applied to the plate to facilitate a pull-off adhesion test. The dollies were sanded by hand with sandpaper (grit size 320) before being pressed into the coating. After the epoxy coating was cured, a one inch diameter hole saw was used to cut the coating down to the metal around the dollies. The pull-off adhesion test was performed using an Instron 4400R with a 1000 lb-load cell and the dollies were pulled vertically at a rate of 0.05 inches/min.

### Results and Discussion

Little or no adhesion was observed on samples for which the polyethylene had not been flame-treated.

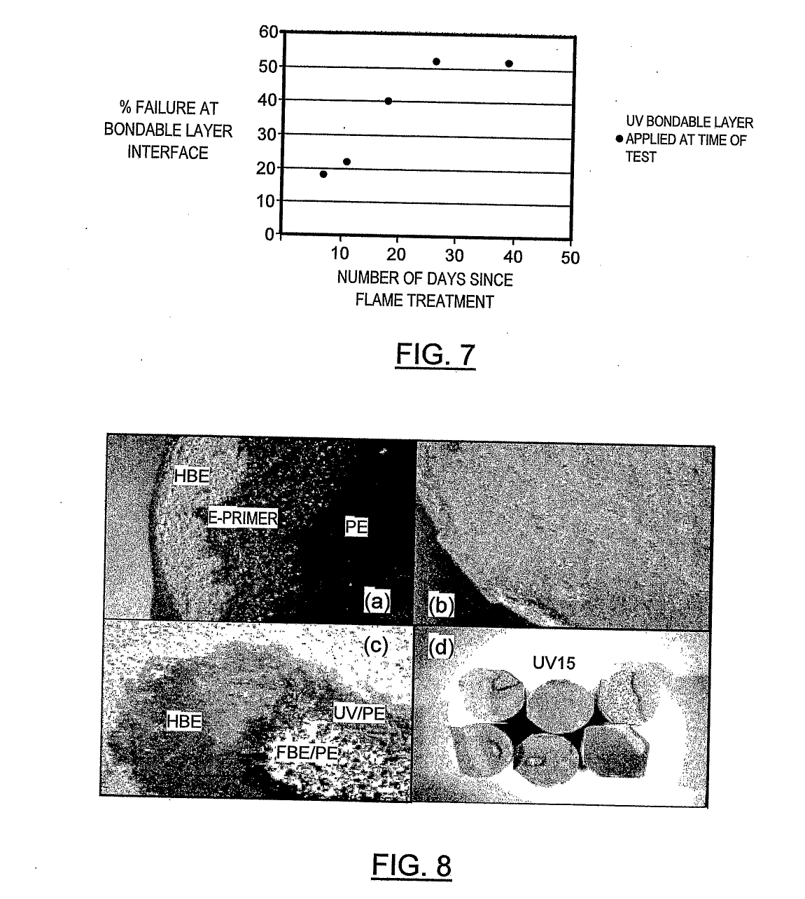

If the bondable layer was applied immediately after flame treatment, failure in the pull-off adhesion test never occurred at the interface between the polyethylene and the bondable layer. However, if there was a significant time interval between surface treatment and application of the bondable layer, a difference was observed in the location of the failure during testing. With the UV curable bondable layer, the amount of failure that occurred at the bondable layer/PE interface increased with this interval (see FIG. 7). Further experimental data and mode of failure for the samples can be found in Tables 2 and 3. The percentage values set out in Tables 2 and 3 refer to the relative percentage of cohesive failure (i.e. 70% HBE=70% of the total bond failure occurred cohesively at the HBE layer) and the relative percentage of adhesion failure (i.e. 30% UV/PE=30% of the total bond failure occurred adhesively at the interface between polyethylene and the UV curable bondable layer).

TABLE 2
Samples with a UV curable bondable layer applied onto the PE surface
at the time of the adhesion test.

| Number | | | | | | | | |
|---|---|---|---|---|---|---|---|---|
| of days | | | | | | | | |
| since | | | | | | | | |
| flame | Peak Forces (lbf) | | | | | | | |
| treatment | 1 | 2 | 3 | 4 | 5 | 6 | Max. (lbf) | Max. (psi) |
| 7 | 660.9 | 601.9 | 672.5 | 811.5 | 541.7 | Pop off | 811.5 | 1836.86025 |
| | 70% | FBE/PE | 10% | 20% | 20% | 20% | | |
| | HBE | | UV/PE, | UV/PE, | UV/PE, | UV/PE, | | |
| | coh., | | 90% HBE | 80% | 80% HBE | 80% | | |
| | 30% | | coh. | HEB | coh. | HBE | | |
| | UV/PE | | | coh. | | coh. | | |
| 11 | 699.3 | 909.8 | 557.6 | 529.7 | 711.4 | Pop off | 909.8 | 2059.36594 |
| | 60% | 70% HBE | 20% | 20% | 20% | | | |
| | UV/HBE, | coh., | UV/PE, | UV/PE, | UV/PE, | | | |
| | 20% | 30% | 80% HBE | 80% | 80% HBE | | | |
| | UV/PE, | UV/PE | coh. | HBE | coh. | | | |
| | 10% | | | coh. | | | | |
| | PE/FBE | | | | | | | |
| 18 | 691 | 523.2 | 556.2 | 638.9 | 668.2 | 727 | 727 | 1645.59138 |
| | 50% | 50% | 40% | 40% | 50% | 10% | | |
| | UV/PE, | UV/PE, | UV/PE, | UV/PE, | UV/PE, | UV/PE, | | |
| | 50% | 50% | 60% HBE | 60% | 50% HBE | 90% | | |
| | HBE coh. | FBE/PE | coh. | HBE | coh. | HBE | | |
| | | | | coh. | | coh. | | |
| 26 | 719.7 | Pop off | 609.1 | 651.5 | Pop off | 484.8 | 719.7 | 1629.06756 |
| | 5% | 90% | 5% | 60% | 90% | 2% | | |
| | FBE/PE, | UV/PE, | FBE/PE, | FBE/PE, | HBE/metal, | FBE/PE, | | |
| | 70% | 10% HBE | 85% | 40% | 10% | 30% | | |
| | HBE | coh. | UV/PE, | UV/PE | UV/PE | HBE | | |
| | coh., | | 10% HBE | | | coh. | | |
| | 25% | | | | | 68% | | |
| | PE/UV | | | | | UV/PE | | |
| 39 | Pop off | 616.9 | 562.4 | 674.4 | 710.1 | 611.8 | 710.1 | 1607.3376 |
| | UV/PE | HBE/metal | HBE/metal | UV/PE | 90% | UV/PE | | |
| | | | | | HBE/metal, | | | |
| | | | | | 10% | | | |
| | | | | | UV/PE | | | |

TABLE 3
Samples with an epoxy bondable layer (E-primer) applied to the PE
surface at the time of the adhesion test.

| Number | | | | | | | | |
|---|---|---|---|---|---|---|---|---|
| of days | | | | | | | | |
| since | | | | | | | | |
| flame | Peak Forces (lbf) | | | | | | | |
| treatment | 1 | 2 | 3 | 4 | 5 | 6 | Max. (lbf) | Max. (psi) |
| 7 | 525.4 | 585 | 460.4 | 791.7 | 425.2 | 510.3 | 791.7 | 1792.04 |
| | 20% E- | 60% | 20% E- | 50% E- | 10% E- | 15% E- | | |
| | primer/PE, | metal/HBE, | primer/PE, | primer | primer/PE, | primer/Pe, | | |
| | 40% E- | 40% E- | 10% | coh., | 90% E- | 60% | | |
| | primer | primer | metal/HBE, | 20% HBE | primer | metal/HBE, | | |
| | coh., | coh. | 70% HBE | coh., | coh. | 25% E- | | |
| | 40% | | coh. | 30% | | primer | | |
| | FBE/PE | | | metal/HBE | | coh. | | |
| 11 | 691.3 | 434.5 | 686.2 | Pop off | Pop off | | 691.3 | 1564.78 |
| | E-primer | 40% E- | E-primer | E-primer | E-primer | | | |
| | coh. | primer | coh. | coh. | coh. | | | |
| | | coh., | | | | | | |
| | | 60% | | | | | | |
| | | FBE/PE | | | | | | |
| 18 | 491.5 | 716.8 | Dolly to | 617.2 | 420.8 | 667.6 | 716.8 | 1622.50 |
| | 15% HBE | 50% E- | close to | 10% HBE | 25% E- | FBE/PE | | |
| | coh., | primer | plate's | coh., | primer/PE, | | | |
| | 40% E- | coh., | edge to | 50% E- | 75% E- | | | |
| | primer/PE, | 50% HBE | test | primer/PE, | primer | | | |
| | 45% E- | coh. | | 40% E- | coh. | | | |
| | primer | | | primer | | | | |
| | coh. | | | coh. | | | | |
| 26 | 515.2 | 903.6 | Pop off | 677 | 847 | Pop off | 903.6 | 2045.33 |
| | 95% E- | 80% E- | 90% E- | 25% | E-primer | E-primer | | |
| | primer | primer | primer | FBE/PE, | coh. | coh. | | |
| | coh., | coh., | coh., | 40% HBE | | | | |
| | 5% HBE | 20% HBE | 10% E- | coh., | | | | |
| | coh. | coh. | primer/PE | 15% | | | | |
| | | | | PE/E- | | | | |
| | | | | primer, | | | | |
| | | | | 20% PE | | | | |
| | | | | coh. | | | | |
| 39 | 309 | 548.5 | Pop off | 462.5 | 527.8 | 461.3 | 548.50 | 1241.55 |
| | 50% | 10% E- | 90% E- | 20% E- | 100% | 100% | | |
| | HBE/metal, | primer/PE, | primer | primer | HBE/metal | HBE/metal | | |
| | 50% E- | 90% | coh., | coh., | | | | |
| | primer | HBE/metal | 10% | 80% | | | | |
| | coh. | | HBE/metal | HBE/metal | | | | |

Examples of the different failure modes observed during the pull-off adhesion tests are documented in FIG. 8. These are photographs of the ends of the pull-off dollies.

1-14. (canceled)

15. A bondably-coated metallic pipe comprising metallic pipe having a low surface energy mainline polymeric coating thereon extending over the pipe except at a bare zone adjacent each end of the pipe that is free from said mainline polymeric coating; a portion of said mainline polymeric coating adjacent each bare zone having been surface activated and having on said surface activated portion a bondable high surface energy polymeric coating.

16. (canceled)

17. The bondably-coated metallic pipe according to claim 15, wherein said low surface energy mainline polymeric coating comprises at least one layer, and is selected from a group consisting of: a two-layer coating, a three-layer coating and a gradient coating and an exterior layer of the low surface energy mainline polymeric coating comprises polyolefin.

18. (canceled)

19. The bondably-coated metallic pipe according to claim 17, wherein said polyolefin comprises polyethylene or polypropylene.

20. The bondably-coated metallic pipe according to claim 15, wherein the bondable high surface energy polymeric coating comprises a thermoplastic having reactive surface groups selected from a group consisting of: a polyurethane; a polyamide, a polystyrene and a polyester.

21. (canceled)

22. The bondably-coated metallic pipe according to claim 15, wherein the bondable high surface energy polymeric coating comprises a solid residue of a curable liquid resin selected from a group consisting of: a polyurethane resin, an epoxy resin, a polyurea resin, an acrylic resin, and a vinyl ether resin.

23-25. (canceled)

26. The bondably-coated metallic pipe according to claim 15, wherein the bondable coating further comprises a colourant.

27. The bondably-coated metallic pipe according to claim 15, wherein the bondable coating has a thickness of between 1 and 5000 μm.

28. The bondably-coated metallic pipe according to claim 15, wherein the bondable coating has a thickness of between 100 and 1000 μm.

29. The bondably-coated metallic pipe according to claim 15, wherein the bondable high surface energy polymeric coating is treatable with an abrasive agent or a chemical agent and wherein treatment of the bondable high surface energy polymeric coating exposes the reactive surface groups on the surface activated portion of the mainline polymeric coating, said reactive surface groups capable of reacting with chemical groups in a liquid resin.

30-52. (canceled)

53. A method of preparing a bondably coated metallic pipe comprising the steps of:
(a) providing a metallic pipe;
(b) applying a low surface energy mainline polymeric coating to the pipe, said low surface energy mainline polymeric coating extending over the pipe except at a bare zone adjacent each end of the pipe;
(c) activating at least a portion of the low surface energy mainline polymeric coating, said portion of the low surface energy mainline polymeric coating being adjacent to a bare zone;
(d) applying a liquid bondable high surface energy polymeric coating to each of the surface activated portions of the mainline polymeric coating; and
(e) solidifying the liquid bondable high surface energy polymeric coating.

54. The method of claim 53, wherein the bondable high surface energy polymeric coating is applied immediately following activation of at least one portion of the surface of the low surface energy mainline polymeric coating.

55. The method of claim 53, wherein the bondable high surface energy polymeric coating is applied within 10 days of activation of at least one portion of the surface of the low surface energy mainline polymeric coating.

56. The method of claim 53, wherein the bondable high surface energy polymeric coating is applied within 5 days of activation of at least one portion of the surface of the low surface energy mainline polymeric coating.

57. The method of claim 53, wherein the at least one portion of surface of the low surface energy mainline polymeric coating is activated by exposing the surface of the low surface energy mainline polymeric coating to a physical oxidizing agent selected from a group consisting of: corona discharge, flame treatment, plasma treatment, or UV irradiation.

58. (canceled)

59. The method of claim 53, wherein the at least one portion of surface of the low surface energy mainline polymeric coating is activated by exposing the surface to a chemical oxidizing agent selected from a group consisting of: chromic acid, a peroxide, and a halogen gas.

60. (canceled)

61. The method of claim 53, wherein the at least one portion of surface of the polymeric coating is activated by grafting a functional polymer to the surface.

62. The method of claim 61, wherein the functional polymer is selected from a group consisting of: an acrylic acid and an acrylic ester.

63. (canceled)

64. The method according to claim 61, wherein the functional polymer comprises an amine group or an epoxy group.

65. (canceled)

66. The method according to claim 53, wherein the liquid bondable high surface energy polymeric coating is applied by a method selected from a group consisting of: brushing, spraying, rolling, reverse roll transfer and extrusion.

67. The method according to claim 53, wherein the liquid bondable high surface energy polymeric coating is solidified by cooling, curing or drying.

68. The method according to claim 53, wherein the bondable high surface energy polymeric coating comprises a thermoplastic having reactive surface groups, said thermoplastic selected from a group consisting of: a polyurethane; a polyamide, a polystyrene and a polyester.

69. The method according to claim 53, wherein the bondable high surface energy polymeric coating comprises a solid residue of a curable liquid resin selected from a group consisting of: a polyurethane resin, an epoxy resin, a polyurea resin, an acrylic resin, and a vinyl ether resin.

70-72. (canceled)

73. A method of preparing a pipeline comprising the steps of:
(a) providing a first and second bondably-coated metallic pipe comprising metallic pipe having a low surface energy mainline polymeric coating thereon extending over the pipe except at a bare zone adjacent each end of the pipe that is free from said mainline polymeric coating; a portion of said mainline polymeric coating adjacent each bare zone having been surface activated and having on said surface activated portion, a bondable coating comprising a high surface energy polymeric coating that will react with and bond to the surface activated mainline coating and will react with and bond to a field joint coating;
(b) mating one bare end of the first bondably-coated metallic pipe with one bare end of the second bondably-coated metallic pipe;
(c) welding the end of the first bondably-coated metallic pipe to the end of the second bondably-coated metallic pipe to provide a welded joint;
(d) treating at least a portion of the surface of the bondable coating with an abrasive agent or a chemical agent to expose a region having enhanced capability for reacting with and bonding to said field joint coating; and
(e) applying said field joint coating to the welded joint and over said exposed region of the bondable coating.

74. (canceled)

75. The method according to claim 73, wherein the abrasive agent is shot, grit, or sand or the chemical agent is detergent or an organic solvent.

76. (canceled)

77. The method according to claim 73, wherein the low surface energy polymeric mainline coating comprises polyethylene or polypropylene, the high surface energy polymeric coating comprises a curable liquid resin selected from a group consisting of: a polyurethane resin, an epoxy resin, a polyurea resin, an acrylic resin, and a vinyl ether resin, and the field joint coating is selected from a group consisting of: a polyurethane liquid resin, an epoxy liquid resin, a polyurea liquid resin, and an acrylic liquid resin.

78-79. (canceled)
